(19) United States
(12) Patent Application Publication
(10) Pub. No.: US 2025/0053820 A1
(43) Pub. Date: Feb. 13, 2025

(54) COMPUTATION GRAPH

(71) Applicant: Nozomu KUBOTA, Tokyo (JP)

(72) Inventor: Nozomu KUBOTA, Tokyo (JP)

(21) Appl. No.: 18/927,631

(22) Filed: Oct. 25, 2024

Related U.S. Application Data
(63) Continuation of application No. PCT/JP2023/016361, filed on Apr. 25, 2023.

(30) Foreign Application Priority Data
Apr. 27, 2022 (JP) 2022-073623

(51) Int. Cl. G06N 3/09

(52) U.S. Cl. CPC G06N 3/09

(57) ABSTRACT

Provided is an information processing method, includes, by one or a plurality of processors included in an information processing device, executing: performing learning by inputting prescribed data into a prescribed learning model that uses a neural network represented by a prescribed computation graph; changing the prescribed data and/or the prescribed computation graph, the changing including changing, from among a function, which is associated with a prescribed node in a prescribed layer within the prescribed computation graph, and an activation function, which receives input of an output value from the function, the function; obtaining a learning result from the learning using the changed prescribed data and/or prescribed computation graph; performing supervised learning using learning data that includes any data and any computation graph with which the learning has been performed, as well as a learning result obtained when learning is performed using the any data and the any computation graph; and generating a predictive model that is generated through the supervised learning, the predictive model outputting a specific computation graph when receiving input of prescribed data.

### TECHNICAL FIELD

The present invention relates to an information processing method, a recording medium, and an information processing device capable of providing an appropriate computation graph.

### BACKGROUND ART

In recent years, research on AI (Artificial General Intelligence) has been conducted, and it is considered that the configurations of neural networks are made more complex to address any problem so as to enhance learning accuracy. The following Patent Document 1 describes correcting a computation graph that represents a function used in a neural network.

### CITATION LIST

### Patent Document

Patent Document 1: Japanese Translation of PCT Application No. 2018-533792

### SUMMARY

### Technical Problem

Here, learning using a neural network is formulated as the optimization of a loss function. Backpropagation is used to minimize the output of a loss function as the optimization of the loss function. One of methods for implementing backpropagation involves creating and reversing a computation graph. At this time, the computation graph is considered to have any configuration by changing the number of nodes within the computation graph, the relationships between edges and nodes, a function associated with each node, or the like.

However, while different computation graphs may be used depending on the types of datasets, problems to be solved, or the like, the currently used computation graphs are not necessarily optimal.

Accordingly, an object of the present invention is to provide an information processing method, a recording medium, and an information processing device capable of providing a more appropriate computation graph that constitutes a neural network.

### Solution to Problem

An aspect of the present invention provides an information processing method, including, by one or a plurality of processors included in an information processing device, executing: performing learning by inputting prescribed data into a prescribed learning model that uses a neural network represented by a prescribed computation graph; changing the prescribed data and/or the prescribed computation graph, the changing including changing, from among a function, which is associated with a prescribed node in a prescribed layer within the prescribed computation graph, and an activation function, which receives input of an output value from the function, the function; obtaining a learning result from the learning using the changed prescribed data and/or prescribed computation graph; performing supervised learning using learning data that includes any data and any computation graph with which the learning has been performed, as well as a learning result obtained when learning is performed using the any data and the any computation graph; and generating a predictive model that is generated through the supervised learning, the predictive model outputting a specific computation graph when receiving input of prescribed data.

### Advantageous Effects of Invention

According to the present invention, it is possible to provide an information processing method, a program, and an information processing device capable of providing a more appropriate computation graph that constitutes a neural network.

### BRIEF DESCRIPTION OF DRAWINGS

FIG. 1 is a diagram showing an example of a system configuration according to an embodiment.

FIG. 2 is a diagram showing an example of the physical configurations of an information processing device according to an embodiment.

FIG. 3 is a diagram showing an example of the processing blocks of the information processing device according to an embodiment.

FIG. 4 is a diagram showing an example of part of a layer according to an embodiment.

FIG. 5 is a diagram showing an example of the processing blocks of the information processing device according to an embodiment.

FIG. 6 is a diagram showing an example of information related to a computation graph according to an embodiment.

FIG. 7 is a diagram showing an example of association data according to an embodiment where information related to prescribed data is associated with information related to an appropriate computation graph.

FIG. 8 is a flowchart showing an example of processing related to the generation of a predictive model according to an embodiment.

FIG. 9 is a flowchart showing an example of processing in the information processing device used by a user according to an embodiment.

### DESCRIPTION OF EMBODIMENTS

Embodiments of the present invention will be described with reference to the accompanying drawings. Note that in the respective drawings, components denoted by the same symbols have the same or similar configurations.

### Embodiments

### <System Configuration>

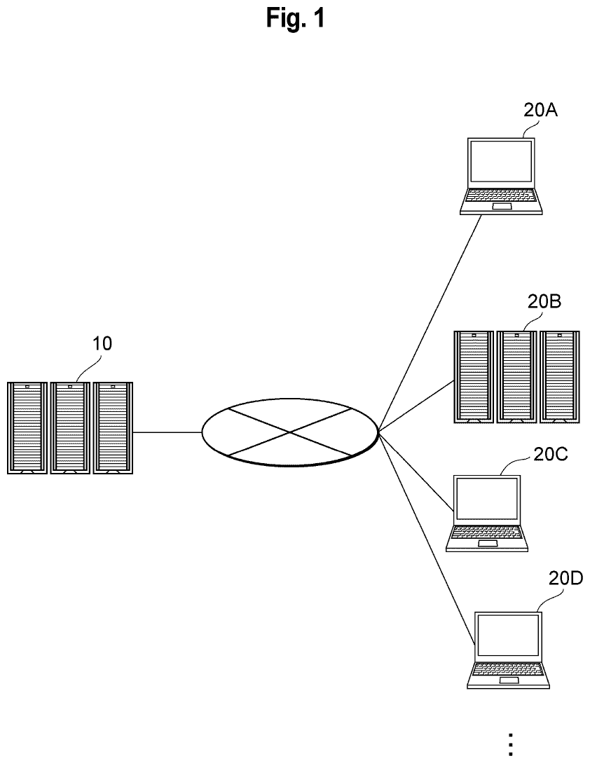

FIG. 1 is a diagram showing an example of a system configuration according to an embodiment. In the example shown in FIG. 1, a server 10 and respective information processing devices 20A, 20B, 20C, and 20D are connected via a network to enable data transmission and reception. When not separately distinguished, the information processing devices will also be referred to as information processing devices 20.

The server 10 is an information processing device capable of collecting and analyzing data and may be constituted by one or a plurality of information processing devices. The information processing devices 20 are information processing devices such as smartphones, personal computers, tablet terminals, servers, and connected cars that are capable of performing machine learning. Note that the information processing devices 20 may also be devices that are directly or indirectly connected to invasive or noninvasive electrodes used to sense brain waves and are capable of analyzing, transmitting, and receiving brain wave data.

In the system shown in FIG. 1, the server 10 performs learning using various datasets, for example, by inputting any of the datasets into a learning model that uses a neural network represented by any of various computation graphs. At this time, the server 10 stores the learning performance acquired using the prescribed dataset and the prescribed computation graph so as to be associated.

Next, using learning results (for example, learning performance) obtained using any dataset and any computation graph as training data, the server 10 learns and generates a predictive model that specifies a computation graph with high learning performance for prescribed data.

As a result, when learning is performed for prescribed data, it becomes possible to provide a more appropriate computation graph that constitutes a neural network. Further, the server 10 may change a computation graph by changing a function associated with each node of the computation graph. Note that this function is desirably a differentiable function in consideration of Backpropagation.

### <Hardware Configurations>

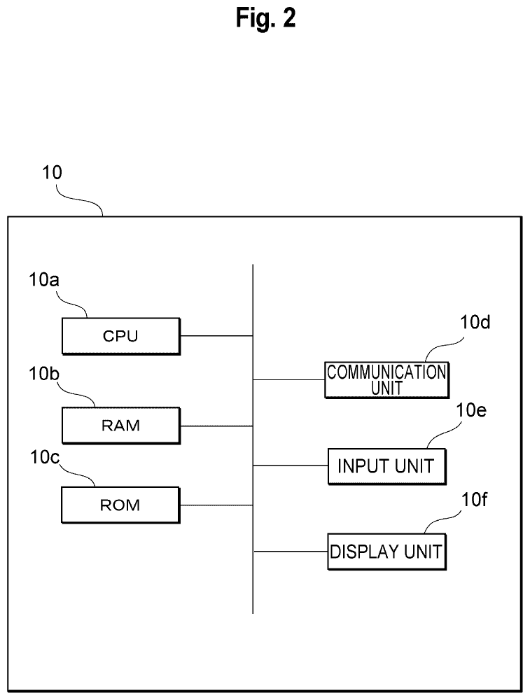

FIG. 2 is a diagram showing an example of the physical configurations of the information processing device 10 according to an embodiment. The information processing device 10 has one or a plurality of CPUs (Central Processing Units) 10a that correspond to computation units, a RAM (Random Access Memory) 10b that corresponds to a storage unit, a ROM (Read only Memory) 10c that corresponds to a storage unit, a communication unit 10d, an input unit 10e, and a display unit 10f. These configurations are connected to enable mutual data transmission and reception via a bus.

This embodiment will describe a case where the information processing device 10 is constituted by one computer. However, the information processing device 10 may also be realized by combining a plurality of computers or a plurality of computation units. Further, the configurations shown in FIG. 2 are provided as an example. The information processing device 10 may also have configurations other than these configurations, or it may lack some of these configurations.

The CPU 10a is a control unit that performs control related to the execution of programs stored in the RAM 10b or the ROM 10c, as well as the computation and processing of data. The CPU 10a is a computation unit that executes a program (learning program) to perform learning to find a more appropriate computation graph using a learning model or a program (predictive program) to perform learning to generate a predictive model that outputs an appropriate computation graph when receiving any data. The CPU 10a receives various data from the input unit 10e or the communication unit 10d, and displays the computation results of the data on the display unit 10f or stores the computation results in the RAM 10b.

The RAM 10b is a storage unit in which data can be rewritten and may be constituted, for example, by a semiconductor storage element. The RAM 10b may store data such as a program to be executed by the CPU 10a, computation graph data related to various computation graphs, a predictive model that predicts an appropriate computation graph, and association data showing the relationships between information related to data for learning and the appropriate computation graphs corresponding to that data. Note that such data is provided as an example. The RAM 10b may also store data other than the exemplified data or may not store some of the exemplified data.

The ROM 10c is a storage unit from which data can be read and may be constituted, for example, by a semiconductor storage element. The ROM 10c may store, for example, a learning program or data that is not to be rewritten.

The communication unit 10d is an interface that connects the information processing device 10 to another equipment. The communication unit 10d may be connected to a communication network such as the Internet.

The input unit 10e receives data input from a user and may include, for example, a keyboard and a touch panel.

The display unit 10f visually displays computation results from the CPU 10a and may be constituted, for example, by an LCD (Liquid Crystal Display). The display of computation results by the display unit 10f can contribute to XAI (explainable AI). The display unit 10f may also display, for example, learning results or function data.

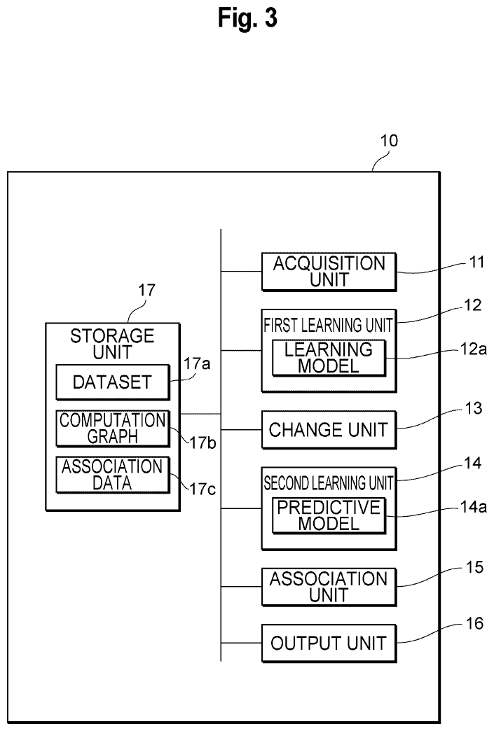

The learning program may be stored and provided on a computer-readable storage medium such as the RAM 10b and the ROM 10c, or it may also be provided via a communication network connected via the communication unit 10d. In the information processing device 10, various operations that will be described later using FIG. 3 are realized when the CPU 10a executes the learning program. Note that these physical configurations are provided as an example and may not be necessarily independent configurations. For example, the information processing device 10 may include an LSI (Large-Scale Integration) in which the CPU 10a, the RAM 10b, and the ROM 10c are integrated. Further, the information processing device 10 may include a GPU (Graphical Processing Unit) or an ASIC (Application Specific Integrated Circuit).

Note that the configurations of the information processing devices 20 are similar to those of the information processing device 10 shown in FIG. 2, and therefore their descriptions will be omitted. Further, the information processing device 10 and the information processing devices 20 needs to include only the CPU 10a, the RAM 10b, and the like as basic configurations to perform data processing, and may not include the input unit 10e or the display unit 10f. Further, the input unit 10e or the display unit 10f may be connected from the outside via an interface.

### <Processing Configurations>

FIG. 3 is a diagram showing an example of the processing blocks of the information processing device 10 according to an embodiment. The information processing device 10 includes an acquisition unit 11, a first learning unit 12, a change unit 13, a second learning unit 14, an association unit 15, an output unit 16, and a storage unit 17. For example, the first learning unit 12, the change unit 13, the second learning unit 14, and the association unit 15 shown in FIG. 3 can be executed and realized by, for example, the CPU 10a or the like, the acquisition unit 11 and the output unit 16 can be realized by, for example, the communication unit 10d or the like, and the storage unit 17 can be realized by the RAM 10b and/or the ROM 10c or the like.

The acquisition unit 11 acquires prescribed data. For example, the acquisition unit 11 may acquire known datasets such as image data, series data, and text data as the prescribed data. Note that the acquisition unit 11 may also acquire data stored in the storage unit 17 or data transmitted by other information processing devices.

The first learning unit 12 performs learning by inputting prescribed data acquired by the acquisition unit 11 into a prescribed learning model 12a that uses a neural network represented by a prescribed computation graph. For example, the first learning unit 12 uses a plurality of learning models 12a with different computation graphs. It may be possible to appropriately select which of the computation graphs is used for a prescribed problem or a prescribed dataset for which learning is performed. Further, the first learning unit 12 obtains learning results (for example, learning performance) from each of the plurality of learning models 12a.

The prescribed problem includes, for example, a problem where at least one of classification, generation, or optimization is performed on at least one of image data, series data, or text data. Here, the image data includes still image data and moving image data. The series data includes voice data or stock data.

Further, the prescribed learning model 12a is a learning model that includes a neural network and includes, for example, at least one of an image recognition model, a series data analysis model, a robot control model, a reinforcement learning model, a voice recognition model, a voice generation model, an image generation model, a natural language processing model, or the like. Further, as a specific example, the prescribed learning model 12a may be any of a CNN (Convolutional Neural Network), an RNN (Recurrent Neural Network), a DNN (Deep Neural Network), an LSTM (Long Short-Term Memory), a bi-directional LSTM, a DQN (Deep Q-Network), a VAE (Variational AutoEncoder), a GAN (Generative Adversarial Network), a flow-based generation model, or the like.

Further, the learning model 12a includes models that have been acquired through pruning, quantization, distillation, or transfer of learned models. Note that these are provided as an example only, and the first learning unit 12 may perform machine learning with learning models for problems other than the above problems.

The change unit 13 changes prescribed data and/or a prescribed computation graph. For example, the change unit 13 sequentially changes prescribed data input to the first learning unit 12 from among a plurality of prescribed data. Further, when learning has been performed for all prescribed data, the change unit 13 selects one from among a plurality of computation graphs to use another computation graph. As a result, it becomes possible to perform learning for any combination of prescribed data and a prescribed computation graph. For example, the change unit 13 may sequentially change prescribed data and/or a prescribed computation graph to ensure that all combinations of prescribed data and prescribed computation graphs are learned, or it may also sequentially change prescribed data and/or a prescribed computation graph until certain conditions are met. Further, the change unit 13 includes changing a first function that is associated with a prescribed node in a prescribed layer within a prescribed computation graph among the first function and an activation function (second function) that receives output values from the first function.

The acquisition unit 11 or the first learning unit 12 obtains learning results from learning using changed prescribed data and/or a changed prescribed computation graph. For example, the acquisition unit 11 or the first learning unit 12 obtains learning results from learning using various combinations of prescribed data and/or prescribed computation graphs.

The first learning unit 12 may also include obtaining learning results by inputting prescribed data changed by the change unit 13 input into the learning model 12a or by inputting prescribed data into the learning model 12a with an applied changed prescribed computation graph for learning. As described above, the first learning unit 12 performs learning using a current learning model 12a when prescribed data is changed. When a prescribed computation graph is changed, the first learning unit 12 performs learning by applying the changed computation graph and then inputting prescribed data into the updated learning model 12a.

The acquisition unit 11 may also include obtaining learning results from another information processing device when learning is performed by the other information processing device using prescribed data and/or a prescribed computation graph changed by the change unit 13. The acquisition unit 11 obtains respective learning results from the respective information processing devices 20 that have performed learning using different prescribed data or different computation graphs. For example, in order to perform distributed learning, the server 10 may transmit any data or any computation graph to the respective information processing devices 20 and instruct the information processing devices 20 to perform learning using the transmitted data or the computation graph.

The second learning unit 14 performs supervised learning using learning data that includes any data and any computation graph with which learning has been performed, as well as learning results obtained when learning has been performed using the data and the computation graph. For example, the second learning unit 14 performs supervised learning using training data that uses learning results (for example, learning performance) from learning using any data and any computation graph as answer labels.

As a specific example, the training data includes training data that uses classification performance obtained from learning using image datasets and various computation graphs as answer labels, training data that uses text recognition results obtained from learning using text datasets and various computation graphs as answer labels, or the like.

Further, the second learning unit 14 generates a predictive model that is generated through supervised learning, where the predictive model outputs a specific computation graph when receiving prescribed data. For example, when receiving any data, the second learning unit 14 generates a predictive model that outputs an appropriate computation graph for this data.

As a specific example, when a predictive model receives image data, the second learning unit 14 outputs an appropriate computation graph on the basis of the characteristics of the image data. The appropriate computation graph refers to, for example, a computation graph with the highest classification performance for the characteristics of the image data among various computation graphs. The various computation graphs include computation graphs different in the number of layers, the number of nodes in each layer, the relationships between nodes and edges, or the like.

According to the above configuration, it becomes possible to provide a more appropriate computation graph that constitutes a neural network for any data (for example, any dataset) by using a predictive model generated by the second learning unit 14.

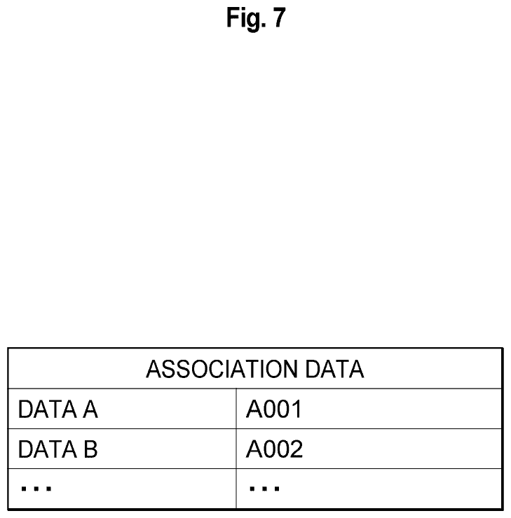

Further, the association unit 15 associates information related to prescribed data with information related to a computation graph that has been output by a predictive model. For example, the association unit 15 stores association data, where characteristic information related to prescribed data is associated with information for identifying a specific computation graph, in the storage unit 17. The association data will be described later using, for example, FIG. 7.

According to the above configuration, the server 10 can specify an appropriate computation graph for data for learning without performing learning, provided that characteristic information related to the data for learning is stored in association data. In this case, the second learning unit 14 may perform learning when the data for learning is not stored in the association data. As a result, processing load on the server 10 can be reduced, enabling an improvement in the processing efficiency of the server 10.

The output unit 16 may output a computation graph that has been predicted by the second learning unit 14 to another information processing device 20. For example, the output unit 16 may transmit prescribed data and output an appropriate computation graph corresponding to the prescribed data to the information processing device 20 that has requested the acquisition of the appropriate computation graph. Further, the output unit 16 may also output the predicted computation graph to the storage unit 17.

Further, the change unit 13 may also include changing a first function that is associated with a prescribed node in a prescribed layer within a prescribed computation graph, where the first function acquires and transforms output values from each node in the layer preceding the prescribed layer. For example, the change unit 13 may change the first function for transforming output values from each node into a single output value to a differentiable function such as a non-linear quadratic function and a cubic function instead of a linear first-order function. This first function needs to be a differentiable function in consideration of Backpropagation.

Generally, when output values from each node in a certain layer are transmitted to the next layer, a linear transformation is performed using a simple function (for example, y=w×x+b). y represents output, w represents a weight matrix, x represents an input vector, and b represents a bias vector.

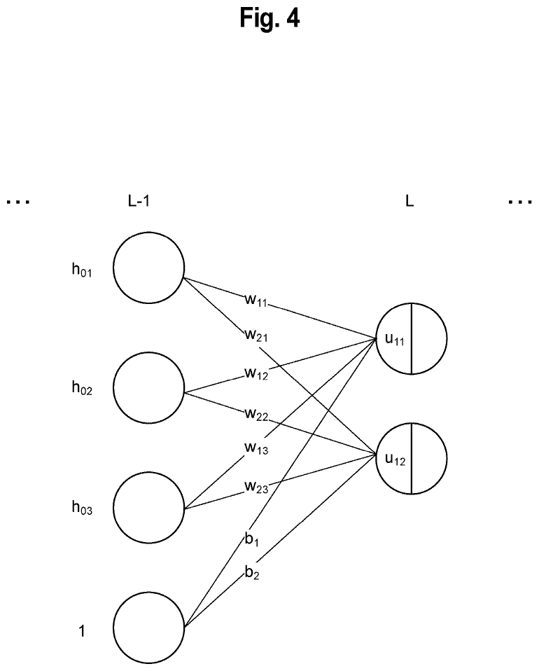

FIG. 4 is a diagram showing an example of a part of a layer according to an embodiment. A layer L−1 shown in FIG. 4 has four nodes, and output values from the respective nodes are h₀₁, h₀₂, h₀₃, and 1. The output value 1 represents a bias. In this case, in each node of the layer L, a linear transformation and a non-linear transformation (activation function) are generally sequentially applied to the output values from the previous layer L−1 to generate output values. Here, the linear transformation is generally performed using the first function u=wh+b. For example, u₁₁ and u₁₂ shown in FIG. 4 are calculated using the following Formulae (1) and (2).

$$\begin{matrix}[ Math . 1 ] & \\ \begin{matrix}{u}_{11} = {w}_{11} {h}_{01} + {w}_{12} {h}_{02} + {w}_{13} {h}_{03} + {b}_{1} & ( 1 ) \\ {u}_{12} = {w}_{21} {h}_{01} + {w}_{22} {h}_{02} + {w}_{23} {h}_{03} + {b}_{2} & ( 2 )\end{matrix} & \end{matrix}$$

Further, the above Formulae can be described as in Formula (7) when an input vector H₀, a weight matrix W₁₀, a bias vector B₁, and output U₁ are defined as follows.

$$\begin{matrix}[ Math . 2 ] & \\ \begin{matrix}{H}_{0} = & [ \begin{matrix}{h}_{01} \\ {h}_{02} \\ {h}_{03}\end{matrix} ] & ( 3 ) \\ {W}_{10} = & [ \begin{matrix}{w}_{11} & {w}_{12} & {w}_{13} \\ {w}_{21} & {w}_{22} & {w}_{23}\end{matrix} ] & ( 4 ) \\ {B}_{1} = & [ \begin{matrix}{b}_{1} \\ {b}_{2}\end{matrix} ] & ( 5 ) \\ {U}_{1} = & [ \begin{matrix}{u}_{11} \\ {u}_{12}\end{matrix} ] & ( 6 )\end{matrix} & \end{matrix}$$

$${U}_{1} = {W}_{10} \times {H}_{0} + {B}_{1} \qquad Formula ( 7 )$$

In the above example, the linear transformation (W₁₀×H₀) is applied to the output values from the previous layer for each node in a computation graph. However, a differentiable function such as a quadratic function and a cubic function may be used as the first function. As a result, the output values of a loss function may be smaller in a case where another non-linear function is used than a case where a linear function is used. That is, small values of a loss function indicate that the error between a correct value and a predicted value is small, and learning performance is high. Note that the output values of the first function are input into a second function that represents an activation function.

The first learning unit 12 performs learning using a computation graph that includes various functions as first functions that are associated with each node and transform output values from a previous layer into a single output value. As a result, it is possible to determine whether output values from a loss function are smaller in a case where a non-linear transformation corresponding to a prescribed function is used than output values from a loss function in a case where a linear transformation is used. If the output values from the loss function are smaller for prescribed data in the case of the non-linear transformation, this is reflected in a predictive model through supervised learning by the second learning unit 14. Accordingly, when data the same as or similar to prescribed data is input into a predictive model, it is expected that a computation graph including a function for a non-linear transformation is output. This computation graph is such a computation graph as to produce smaller output values from a loss function, thereby enabling an improvement in learning performance. Further, various computation graphs include graphs that, although having the same configurations such as the number of nodes and edges, have different functions associated with each node.

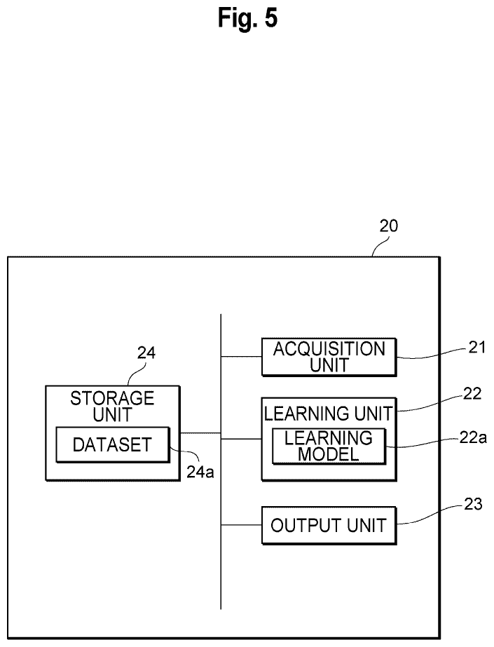

FIG. 5 is a diagram showing an example of the processing blocks of the information processing device 20 according to an embodiment. The information processing device 20 includes an acquisition unit 21, a learning unit 22, an output unit 23, and a storage unit 24. The information processing device 20 may be constituted by a general-purpose computer.

The acquisition unit 21 may acquire, along with instructions for distributed learning, information related to a prescribed computation graph or information related to a prescribed dataset from another information processing device (for example, the server 10). The information related to the prescribed computation graph may include information showing the configuration of the computation graph or information showing a function that is associated with each node of the computation graph and transforms output values from a previous layer. The information related to the prescribed dataset may include the dataset itself or information showing a storage destination where the prescribed dataset is stored.

The learning unit 22 performs learning by inputting a prescribed dataset for learning into a learning model 22a that performs learning using a prescribed computation graph. The learning unit 22 controls the feedback of learning results after the learning to the server 10. The learning results may include, for example, learning performance or the like, and may also include learning time. The learning unit 22 may select the learning model 22a on the basis of the type of the dataset for learning and/or a problem to be solved.

Further, the prescribed learning model 22a is a learning model that includes a neural network and includes, for example, at least one of an image recognition model, a series data analysis model, a robot control model, a reinforcement learning model, a voice recognition model, a voice generation model, an image generation model, a natural language processing model, or the like. Further, as a specific example, the prescribed learning model 22a may be any of a CNN (Convolutional Neural Network), an RNN (Recurrent Neural Network), a DNN (Deep Neural Network), an LSTM (Long Short-Term Memory), a bi-directional LSTM, a DQN (Deep Q-Network), a VAE (Variational AutoEncoder), a GAN (Generative Adversarial Network), a flow-based generation model, or the like.

Further, the learning model 22a includes models that have been acquired through pruning, quantization, distillation, or transfer of learned models. Note that these are provided as an example only, and the learning unit 22 may perform machine learning with learning models for problems other than the above problems.

The output unit 23 outputs information related to the learning results of distributed learning to another information processing device. For example, the output unit 23 outputs information related to learning results from the learning unit 22 to the server 10. For example, the information related to the learning results through the distributed learning may include learning performance, and may also include learning time as described above.

The storage unit 24 stores data related to the learning unit 22. The storage unit 24 stores a prescribed dataset 24a, data acquired from the server 10, data under learning, information related to learning results, or the like.

As a result, according to instructions from another information processing device (for example, the server 10), the information processing device 20 is enabled to perform distributed learning on a prescribed dataset with an applied prescribed computation graph and provide feedback on learning results to the server 10.

Further, the output unit 23 outputs information related to prescribed data to another information processing device (for example, the server 10). The output unit 23 may output the prescribed data (for example, a dataset for learning) or characteristic information about the prescribed data.

The acquisition unit 21 acquires a computation graph corresponding to prescribed data from another information processing device. The acquired computation graph is one that has been predicted by the other information processing device using a predictive model and is suitable for the prescribed data. Further, the prescribed computation graph may include a first function that is specified according to the prescribed data among the first function that is associated with a prescribed node in a prescribed layer and an activation function that receives output values from the first function.

The learning unit 22 applies an acquired computation graph to the prescribed learning model 22a. At this time, the computation graph may also be applied to the learning model 22a that has been used in the learning described above. Further, the learning model 22a may also be a learning model acquired from another information processing device 10 or a learning model managed by the own device.

The learning unit 22 inputs prescribed data into the learning model 22a with the applied computation graph to obtain learning results. Since the learning results are obtained by performing learning with the computation graph suitable for the prescribed data, it is possible to achieve an improvement in learning performance.

Further, the acquisition unit 21 may also include acquiring, as an acquired computation graph, a first function that is associated with a prescribed node in a prescribed layer within the computation graph, where the first function acquires and transforms output values from each node in the layer preceding the prescribed layer. As a result, a linear transformation is generally used as a method for acquiring and changing each output value from the previous layer. However, any differentiable transformation method may be used to improve learning performance.

### <Data Examples>

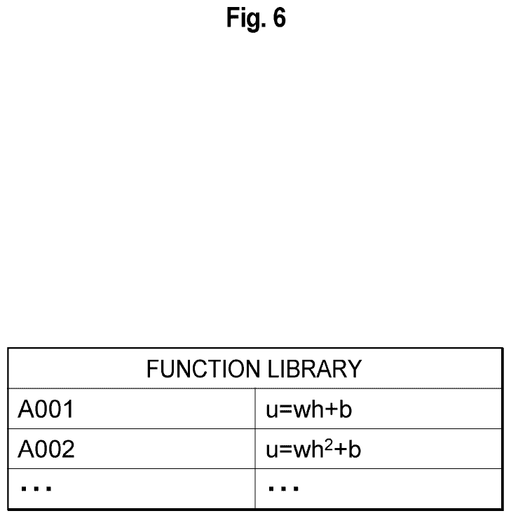

FIG. 6 is a diagram showing an example of information related to a computation graph according to an embodiment. In the example shown in FIG. 6, a first function is associated for each function ID as the information related to the computation graph. An example of various computation graphs is a computation graph where any first function is associated with each node of the computation graph. As a specific example, a first-order function “u=wh+b” is associated with each node as a function for a function ID “A001,” and a quadratic function “u=wh²+b” is associated with each node as a function for a function ID “A002.” Note that as an example of various computation graphs, any function that receives output values from a previous layer is described above. However, a computation graph with any number of layers, any number of nodes in each layer, and any relationship between nodes and edges may also be included. Note that the data shown in FIG. 6 is an example of the data of the computation graph 17b shown in FIG. 3.

FIG. 7 is a diagram showing an example of association data according to an embodiment where information related to prescribed data is associated with information related to an appropriate computation graph. In the example shown in FIG. 7, a first function with a function ID “A001” is associated with a type A of a dataset, and a first function with a function “A002” is associated with a type B of data. Note that the data shown in FIG. 7 is an example of the association data 17c shown in FIG. 3.

### <Operations>

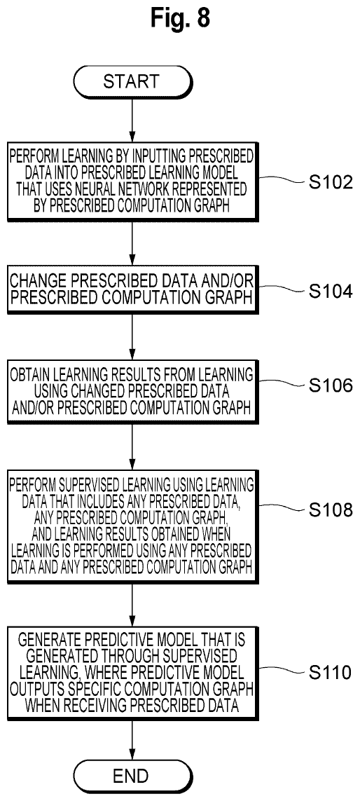

FIG. 8 is a flowchart showing an example of processing related to the generation of a predictive model according to an embodiment. The processing shown in FIG. 8 is executed by the information processing device 10.

In step S102, the first learning unit 12 of the information processing device 10 performs learning by inputting prescribed data into a prescribed learning model that uses a neural network represented by a prescribed computation graph. The prescribed data may be selected from the dataset 17a of the storage unit 17, received from another device via a network, or input according to a user operation. Further, the prescribed computation graph needs to have only a first computation graph set as the default.

In step S104, the change unit 13 of the information processing device 10 changes the prescribed data and/or the prescribed computation graph. The change unit 13 changes data for learning or a computation graph on the basis of a prescribed reference. The change unit 13 may also include changing a first function that is associated with a prescribed node in a prescribed layer within the prescribed computation graph among the first function and an activation function that receives output values from the first function.

In step S106, the first learning unit 12 of the information processing device 10 obtains learning results from learning using the changed prescribed data and/or the prescribed computation graph.

In step S108, the second learning unit 14 of the information processing device 10 performs supervised learning using learning data that includes any data and any computation graph with which the learning has been performed, as well as learning results obtained when learning is performed using the data and the computation graph.

In step S110, the second learning unit 14 of the information processing device 10 generates a predictive model that is generated through the supervised learning, where the predictive model outputs a specific computation graph when receiving prescribed data.

Through the above processing, it becomes possible to provide a more appropriate computation graph that constitutes a neural network by using a generated predictive model.

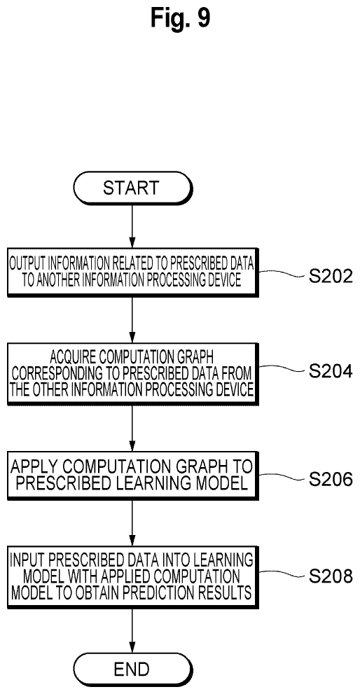

FIG. 9 is a flowchart showing an example of processing in the information processing device 20 used by a user according to an embodiment. In step S202, the output unit 23 of the information processing device 20 outputs information related to prescribed data for learning to another information processing device (for example, the server 10).

In step S204, the acquisition unit 21 of the information processing device 20 acquires information showing a computation graph corresponding to the prescribed data from the other information processing device (for example, the server 10). The acquired computation graph may include a first function that is specified according to the prescribed data among the first function that is associated with a prescribed node in a prescribed layer and an activation function that receives output values from the first function.

In step S206, the learning unit 22 of the information processing device 20 applies the acquired computation graph to the prescribed learning model 22a.

In step S208, the learning unit 22 of the information processing device 20 inputs the prescribed data into the learning model 22a with the applied computation graph to obtain learning results.

As a result, even an information processing device on an edge side can achieve an improvement in learning performance by acquiring an appropriate computation graph for data for learning and performing learning.

The embodiments described above aim to facilitate the understanding of the present invention and should not be used to interpret the present invention in a limiting manner. The respective elements provided in the embodiments and their arrangements, materials, conditions, shapes, sizes, or the like are not limited to those illustrated in the embodiments but can be changed as necessary. Further, it is also possible to partially replace or combine the configurations shown in the different embodiments. Further, a device including the first learning unit 12 and a device including the second learning unit 14 may be different computers. In this case, generated learning results obtained through learning by the first learning unit 12 may be transmitted to the device including the second learning unit 14 via a network.

Further, the information processing device 10 may not necessarily include the change unit 13. For example, the information processing device 10 may acquire learning performance for each group of any data for learning and any computation graph, and perform learning with the second learning unit 14.

### REFERENCE SIGNS LIST

10 Information processing device
10a CPU
10b RAM
10c ROM
10d Communication unit
10e Input unit
10f Display unit
11 Acquisition unit
12 First learning unit
12a Learning model
13 Change unit
14 Second learning unit
14a Predictive model
15 Association unit
16 Output unit
17 Storage unit
17a Dataset
17b Computation graph
17c Association data
21 Acquisition unit
22 Learning unit
22a Learning model
23 Output unit
24 Storage unit
24a Dataset

What is claimed is:

1. An information processing method, comprising, by one or a plurality of processors included in an information processing device, executing:
performing learning by inputting prescribed data into a prescribed learning model that uses a neural network represented by a prescribed computation graph;
changing the prescribed data and/or the prescribed computation graph, the changing including changing, from among a function, which is associated with a prescribed node in a prescribed layer within the prescribed computation graph, and an activation function, which receives input of an output value from the function, the function;
obtaining a learning result from the learning using the changed prescribed data and/or prescribed computation graph;
performing supervised learning using learning data that includes any data and any computation graph with which the learning has been performed, as well as a learning result obtained when learning is performed using the any data and the any computation graph; and
generating a predictive model that is generated through the supervised learning, the predictive model outputting a specific computation graph when receiving input of prescribed data.

2. The information processing method according to claim 1, wherein
the obtaining includes obtaining the learning result through the learning using the changed data and/or computation graph.

3. The information processing method according to claim 1, wherein
the obtaining includes obtaining the learning result from another information processing device that has performed the learning using the changed data and/or computation graph.

4. The information processing method according to claim 1, wherein
the one or the plurality of processors further execute associating information related to the prescribed data with information related to the computation graph.

5. The information processing method according to claim 1, wherein
the changing includes changing the function that acquires and transforms an output value from each node in a layer preceding the prescribed layer.

6. A computer-readable recording medium having recorded thereon a program that causes one or a plurality of processors included in an information processing device to execute:
performing learning by inputting prescribed data into a prescribed learning model that uses a neural network represented by a prescribed computation graph;
changing the prescribed data and/or the prescribed computation graph, the changing including changing, from among a function, which is associated with a prescribed node in a prescribed layer within the prescribed computation graph, and an activation function, which receives input of an output value from the function, the function;
obtaining a learning result from the learning using the changed prescribed data and/or prescribed computation graph;
performing supervised learning using learning data that includes any prescribed data, any prescribed computation graph, and a learning result obtained when learning is performed using the any prescribed data and the any prescribed computation graph; and
generating a predictive model that is generated through the supervised learning, the predictive model outputting a specific computation graph when receiving input of prescribed data.

7. An information processing device including one or a plurality of processors, the one or the plurality of processors executing:
performing learning by inputting prescribed data into a prescribed learning model that uses a neural network represented by a prescribed computation graph;
changing the prescribed data and/or the prescribed computation graph, the changing including changing, from among a function, which is associated with a prescribed node in a prescribed layer within the prescribed computation graph, and an activation function, which receives input of an output value from the function, the function;
obtaining a learning result from the learning using the changed prescribed data and/or prescribed computation graph;
performing supervised learning using learning data that includes any prescribed data, any prescribed computation graph, and a learning result obtained when learning is performed using the any prescribed data and the any prescribed computation graph; and
generating a predictive model that is generated through the supervised learning, the predictive model outputting a specific computation graph when receiving input of prescribed data.
